(19) United States
(12) Patent Application Publication
(10) Pub. No.: US 2009/0327176 A1
(43) Pub. Date: Dec. 31, 2009

(54) SYSTEM AND METHOD FOR LEARNING

(75) Inventor: Reiji Teramoto, Tokyo (JP)

Correspondence Address: YOUNG & THOMPSON, 209 Madison Street, Suite 500, Alexandria, VA, 22314, US

(73) Assignee: NEC Corporation, Tokyo (JP)

(21) Appl. No.: 12/487,178

(22) Filed: Jun. 18, 2009

(30) Foreign Application Priority Data
Jun. 25, 2008 (JP) 2008-165594

(51) Int. Cl. G06F 15/18; G06F 1/02

(52) U.S. Cl. 706/12; 708/270; 706/25

(57) ABSTRACT

A method of learning discriminant function for predicting label information by using computer includes: receiving training data including attribute data and label information, to create an initial prediction model based on the attribute data and the label information; calculating, based on the initial prediction model used as a discriminant function, a gradient of a loss function, which is differentiable with respect to the discriminant function and satisfies a monotonous convex function, from the discriminant function and the label information; creating a prediction model from the attribute data and the gradient while assuming that the gradient is label information of each sample of the training data; and updating the discriminant function based on the created prediction model.

This application is based upon and claims the benefit of priority from Japanese patent application No. 2008-165594 filed on Jun. 25, 2008, the disclosure of which is incorporated herein in its entirety by reference.

### TECHNICAL FIELD

The present invention relates to a system, a method and a program for learning and, more particularly, a system and a method that learn a discriminant function and are capable of predicting label information from attribute data. The present invention also relates to a system, a method and a program for predicting label information from attribute data.

### BACKGROUND ART

There is known a learning system that obtains a discriminant function for performing label judgment by using training data including attribute data and label information. The learning technique using the training data attached with a label is referred supervised learning, if the number of labels for positive examples distributed in the training data is equal to the number of labels for negative examples distributed, a superior discriminant function can be obtained as the result of the learning. However, there often arises a case where the number of positive examples prepared is not equal to the number of negative examples prepared. If the label distribution of positive examples and negative examples is extremely imbalanced, a superior discriminant function cannot be obtained.

In the learning of a discriminant formula, it is desired for the learning to suppress occurring of pseudo-positive and pseudo-negative examples even if the label distribution of the training data is imbalanced. As a performance index of classification learning that takes into consideration the case of imbalanced label distribution, there is known a ROC curve (receiver operating characteristic curve), which is widely used in this field. The ROC curve is obtained by plotting negative examples and positive examples of the training data on the abscissa (X-axis) and ordinate (Y-axis), respectively, in the descending order of the predicted score of the samples in the training data, and connecting the coordinates (x,y) that provide respective scores.

Assuming that the learning system using a specific discriminant function can completely classify the positive examples and negative examples, the ROC curve first advances along the ordinate and then advances parallel to the abscissa. On the other hand, if the positive examples and negative examples are predicted at random, the ROC curve is configured by a diagonal line that represents y=x, so long as the positive examples and negative examples are normalized at “1”. Accordingly, a learning system that provides a larger AUC (area under the curve), i.e., a larger area under the ROC curve, is considered as a better learning system.

Generally, in the supervised learning system, the purpose thereof is to maximize the true rate for prediction. Thus, if the labels for the positive examples and negative examples are imbalanced in the distribution of training data, the AUG cannot be necessarily improved. To solve this problem, a learning technique is proposed wherein distribution of positive examples and negative examples as well as the pseudo-positive examples and pseudo-negative examples are taken into consideration (refer to non-patent literatures-1 and -2). In the non-patent literature-1, the positive examples and negative examples are subjected to re-sampling in accordance with the binomial distribution, to perform a “bagging”. The bagging is described in a non-patent literature-3. In the non-patent literature-2, weight is assigned to a minority class, and re-sampling of the majority class is performed in number of samples equal to the number of total samples in all the classes, thereby performing a random forest.

### LIST OF RELATED DOCUMENTS

Non-patent literature-1: Hido, S., Kashima, H., “Roughly balanced bagging for imbalanced data”, Proceeding of the 2008 SIAM International Conference on Data Mining, 2008.

Non-patent literature-2: Chen, C., Liaw, A., Breiman, L., “Using random forest to learn-imbalanced-data”, Technical report, Department of Statistics, University of California, Berkeley, 2004.

Non-patent literature-3: Breiman, L., “Bagging predictors”, Machine Learning, 24, 123-140, 1996.

In the technique of non-patent literature-1, although the performance of learning is evaluated using the AUC, the learning does not directly maximize the AUC. For this reason, this learning is not an optimum technique in the view point of improvement of the AUC. In the technique of non-patent literature-2, it is needed to perform trial-and-error determination of the costs for the pseudo-positive and pseudo-negative examples. More specifically, this technique is not directed to maximization of the AUC, and enormous time and energy is needed to search the learning parameters that maximize the AUC. In addition, the determination of cost, derivation of the learning algorithm and prediction performance in the non-patent literature-2 are not theoretically justified.

### SUMMARY OF THE INVENTION

It is an object of the present invention to provide a system, a method and a program, that are capable of obtaining a discriminant function having a higher prediction accuracy even if the label distribution is imbalanced.

It is another object of the present invention to provide a system, a method and a program, that are capable of predicting label information of test data.

The present invention provides a first method using a computer, including: receiving training data including attribute data and label information, to create an initial prediction model based on the attribute data and the label information; calculating, based on the initial prediction model used as a discriminant function, a gradient of a loss function, which is differentiable with respect to the discriminant function and satisfies a monotonous convex function, from the discriminant function and the label information; creating a prediction model from the attribute data and the gradient while assuming that the gradient is label information of each sample of the training data; and updating the discriminant function based on the created prediction model.

The present invention also provides a second method that includes the first method and additionally includes receiving test data including attribute data, to predict label information of the test data based on the attribute data of the test data and the discriminant function.

The present invention also provides a first system using a computer, including: an initial-prediction-model creation section that receives training data including attribute data and label information, to create an initial prediction model based on the attribute data and the label information; a gradient calculation section that calculates, based on the initial prediction model used as a discriminant function, a gradient of a loss function, which is differentiable with respect to the discriminant function and satisfies a monotonous convex function, from the discriminant function and the label information; a prediction-model creation section that creates a prediction model from the attribute data and the gradient while assuming that the gradient is label information of each sample of the training data; and an update section that updates the discriminant function based on the created prediction model.

The present invention also provides a second system that includes the sections of the first system and additionally includes a Judgment section that receives test data including attribute data, to predict label information of the test data based on the attribute data of the test data and the discriminant function.

The present invention provides a first computer-readable medium encoded with a computer program running on a computer, the computer program causes the computer to: receive training data including attribute data and label information, to create an initial prediction model based on the attribute data and the label information; calculate, based on the initial prediction model used as a discriminant function, a gradient of a loss function, which is differentiable with respect to the discriminant function and satisfies a monotonous convex function, from the discriminant function and the label information; create a prediction model from the attribute data and the gradient while assuming that the gradient is label information of each sample of the training data; and update the discriminant function based on the created prediction model.

The present invention also provides a second computer readable medium wherein the program causes the computer to execute the processings of the first computer-readable medium and further to receive test data including attribute data, and predict label information of the test data based on the attribute data of the test data and the discriminant function.

The above and other objects, features and advantages of the present invention will be more apparent from the following description, referring to the accompanying drawings.

### BRIEF DESCRIPTION OF THE DRAWINGS

FIG. 1 is a block diagram showing a label prediction system including a learning system configured by a computer according to an embodiment of the present invention.

FIG. 2 is a block diagram showing the learning system shown in FIG. 1.

FIG. 3 is a flowchart showing a procedure of the learning system shown in FIG. 1.

### EXEMPLARY EMBODIMENT

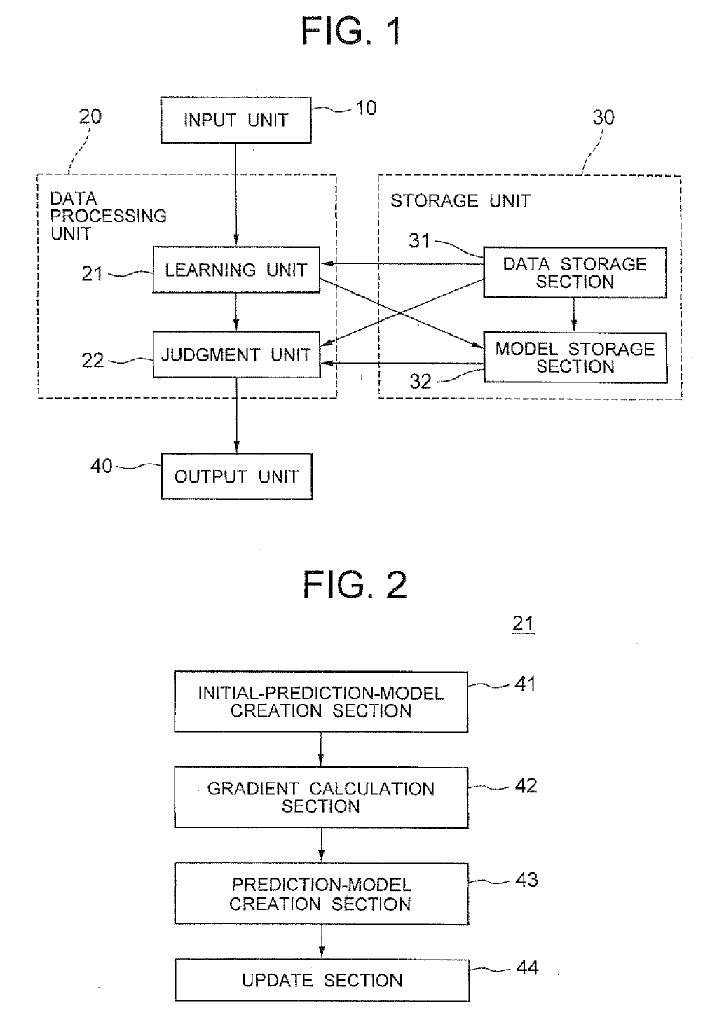

Now, an exemplary embodiment of the present invention will be described with reference to accompanying drawings. FIG. 1 shows a label prediction system including a learning system according to an exemplary embodiment of the present invention. The label prediction system includes an input unit 10, a data processing unit 20, a storage unit 30, and an output unit 40. The input unit 10 includes a keyboard, for example. The data processing unit 20 operates based on the control by at least one program recorded on the storage unit 30. The storage unit 30 stores therein the program and information including training data and test data. The output unit 40 includes a display unit and a printer, for example.

The data processing unit 20 includes a learning unit (or learning system) 21 and a judgment unit 22. The learning unit 21 performs learning on a prediction model (discriminant function) based on training data stored beforehand. The judgment unit 22 predicts a label for test data by using the discriminant function. These sections 21 and 22 are configured by the program stored in the storage unit 30. The storage unit 30 includes a data storage section 31 and a model storage section 32, in addition to the program storage section not shown. The data storage section 31 stores therein the training data used for the learning in the leaning unit 21, and the test data for which a label is to be predicted by the judgment unit 22. The model storage section 32 stores therein the discriminant function obtained as a result of the learning by the learning unit 21. The training data includes attribute data (feature vector) and a label (class). The test data includes attribute data having a dimension similar to the dimension of the training data.

FIG. 2 shows the detailed configuration of the learning unit 21 shown in FIG. 1. The learning unit 21 includes an initial-prediction-model creation section 41 that receives training data including the attribute data and label information, to create an initial prediction model based on the attribute data and the label information; a gradient calculation section 42 that calculates, based on the initial prediction model used as a discriminant function, a gradient of a loss function, which is differentiable with respect to the discriminant function and satisfies a monotonous convex function, from the discriminant function and the label information; a prediction-model creation section 43 that creates a prediction model from the attribute data and the gradient while assuming that the gradient is label information of each sample of the training data; and an update section 44 that updates the discriminant function based on the created prediction model.

An operator provides an instruction for execution of learning to the learning unit 21 through the input unit 10. When the execution instruction is input to the learning unit 21, the learning unit 21 reads the training data from the data storage section 31, and performs learning by using the training data. More specifically, the initial-prediction-model creation section 41 receives the training data, to create an initial prediction model based on the attribute data and the label information. The gradient calculation section 42 calculates a gradient of the loss function from the discriminant function and the label information. The prediction-model creation section 43 creates the prediction model from the attribute data and the gradient while assuming that the gradient is label information of each sample of the training data. The update section 44 updates the discriminant function based on the created prediction model. The learning system iterates these processings as a learning procedure to obtain the prediction model. The learning unit 21 stores the discriminant function thus obtained by the learning in the model storage section 32.

The operator then instructs execution of label prediction to the judgment unit 22 through the input unit 10 after completion of the learning by the learning unit 21. The judgment unit 22 obtains the discriminant function from the model storage section 32, and predicts a label from attribute data of the test data by using the discriminant function, after the execution instruction is input.

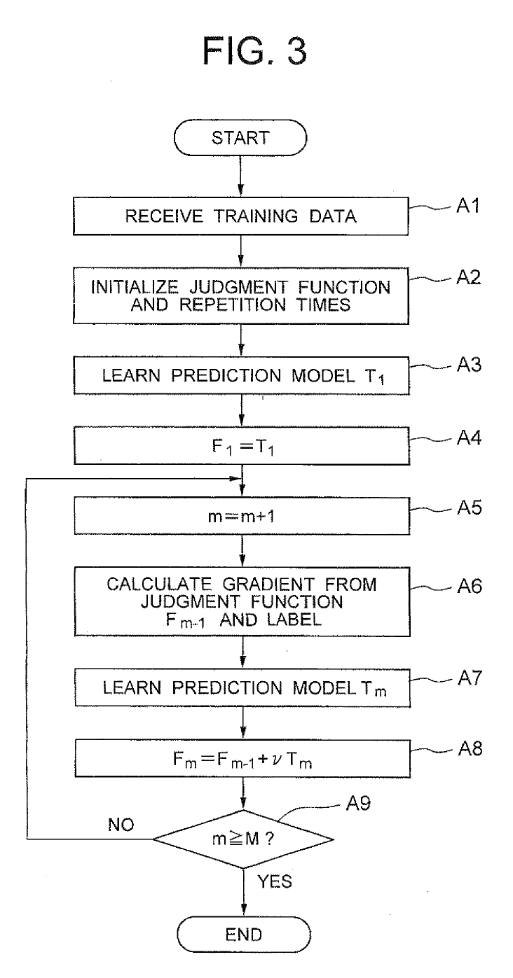

FIG. 3 shows a procedure of the learning unit 21 shown in FIG. 1. The learning unit 21 receives the training data from the data storage section 31 (step A1). The learning unit 21 initializes the discriminant function F₀ to F₀=0, and also initializes the number of repetition times, m, to m=1 (step A2). The learning unit 21 performs learning based on the attribute data and the label of training data while using a decision tree (step A3). The technique of performing the learning by using the decision tree and the data with label is well known in this art, and thus detailed description thereof is omitted here. The learning performed in step A3 is not limited to the use of decision tree, and the learning can use instead the technique of supervised learning, such as a support vector machine and a neural network, etc. that are generally used in the machine learning technique.

The learning unit 21 substitutes, for the discriminant function F₁, the initial prediction model T₁ of the decision tree learned in step A3 (step A4). That is, the learning unit 21 uses the initial prediction model T₁ as the discriminant function F₁ for the number of repetition times, m=1. The learning unit 21 increments the number of repetition times from m=1 (step A5). The learning unit 21 calculates a gradient from the latest discriminant function Fₘ₋₁ and the label of training data so that the AUC assumes a maximum value (step A6). More specifically, the learning unit 21 introduces a loss function that allows the AUC to assume a maximum, and calculates a gradient of the loss function for each sample.

Hereinafter, calculation of the gradient will be described. The AUC is defined as follows:

$$A U C = \frac{{\sum }_{i = 1}^{p} {\sum }_{j = 1}^{n} I [ ( F ( {x}_{i}^{+} ) - F ( {x}_{j}^{-} ) ) ]}{pn} \qquad ( 1 )$$

where “p” and “n” are the sample number of the positive examples and negative examples, respectively, x⁺ᵢ is the feature vector (attribute data) of the i-th sample of the positive examples in the training data, and x⁻ⱼ is the feature vector of the j-th sample of the negative examples in the training data. F(x) is the discriminant function.
I[s] is an indicator function, that is expressed by:

$$I [ s ] = \{ \begin{matrix}0 & if s > 0 \\ 1 & if s < 0\end{matrix}$$

In order to maximize the AUC, the loss function is introduced which is differentiable with respect to the discriminant function and satisfies a monotonous convex function. More specifically, the loss function, L, is defined as follows:

$$L = {\sum }_{k = 1}^{N} exp ( - \frac{1}{\vert {X}_{{y}_{k}}^{*} \vert} {\sum }_{l ∈ {X}_{{y}_{k}}^{*}} {y}_{k} ( F ( {x}_{k} ) - F ( {x}_{l} ) ) ) \qquad ( 2 )$$

, where N is the total number of samples in the training data, yₖ satisfies yₖ∈{+1, −1}, and X*yₖ is a set of samples having a label that is opposite to the label of yₖ.

The gradient rₖ of the loss function for each sample can be obtained by differentiating the above loss function L with respect to the discriminant function, such as by calculation of:

$$\begin{matrix}{r}_{k} = - \frac{\partial L}{\partial F ( {x}_{k} )} \\ = {y}_{k} exp ( - \frac{1}{\vert {X}_{{y}_{k}}^{*} \vert} {\sum }_{l ∈ {X}_{{y}_{k}}^{*}} {y}_{k} ( F ( {x}_{k} ) - F ( {x}_{l} ) ) )\end{matrix}$$

It is to be noted that the above loss function L is a mere example of the usable loss function, and the indicator between the parentheses of the indicator function is not limited to the above example. The indicator may be a function that is an approximation of the AUC expressed by formula (1) and is differentiable with respect to the discriminant function F(x). The loss function L is not limited to the above exponential function, exp( . . . ), so long as the loss function is a convex function.

The learning unit 21 construes that the gradient for each sample obtained in step A6 is a label, and learns the prediction model Tₘ by using the decision tree (step A7). The learning unit 21 creates the discriminant function Fₘ for the m-th repetition time from the discriminant function Fₘ₋₁ obtained in the last repetition time and the prediction model Tₘ obtained in step A7 (step A8). More specifically, the learning unit 21 creates the discriminant function Fₘ based on the formula Fₘ=Fₘ₋₁+ν Tₘ in step A8. Here, ν is a normalized term and satisfies 0<ν≦1. By selecting a smaller value, such as 0.01, for the ν, a possible over-training can be avoided.

The learning unit 21 judges whether or not the number, m, of repetition times has reached a specific number, M, determined beforehand (step A9). The specific number, M, of the repetition times may be determined at 100 or 200, for example. If the number, m, of repetition times has not reached the specific number M, the process returns to step A5, wherein the learning unit 21 increments the number of repetition times. Then, in step A6, the learning unit 21 calculates the gradient of the loss function for each sample from the discriminant function and label. The learning unit 21 iterates the steps A5 to A9 until the number, m, of repetition times reaches the specific number M. The learning unit 21, upon judging that the number, m, of repetition times has reached the specific number M, stores the discriminant function Fₘ in the model storage section 32 as the result of learning.

From the definitional equation of AUC expressed by formula (1), it is judged that the AUC itself is not a convex function. Thus, a loss function that is differentiable with respect to the discriminant function and satisfies a monotonous convex function may be used as the loss function herein. Use of such a loss function enables the learning to obtain a maximum AUC. Gradient boosting is a learning algorithm that optimizes the loss function by using a gradient technique. The gradient boosting is described in a literature (Friedman, J., Hastie, T., Tibshirani, R. “Additive logistic regression: a statistical-view-of-boosting”, Ann. Statist., 28, 37-407, 2000).

The judgment unit 22 reads the discriminant function created in the procedure shown in FIG. 3 from the model storage section 32. The judgment unit 22 reads the test data from the data storage section 31, applies the attribute data in the test data to the discriminant function, and obtains the prediction result of the label for each test data. The judgment unit 22 outputs the thus predicted result of the test data to the output unit 40.

In the present embodiment, a monotonous convex function that is differentiable with respect to the discriminant function is considered as the loss function. The gradient of such a loss function obtained for each sample is construed as the label in the learning of the prediction model, to update the discriminant function. In the present embodiment, the boosting using the loss function that maximizes the AUC allows calculation of the discriminant function that directly maximizes the AUC. That is, a discriminant function that provides a higher prediction accuracy can be obtained. The judgment unit 22, which performs the label prediction using such a discriminant function, acts as a classifier that can predict the label with a higher accuracy.

For using the prediction system of the above embodiment in the field of medical science or biology, the label information may be presence or absence of disease or medicinal effect, degree of development in the clinical condition etc. In an alternative, the label information may be the survival time length. If the label data includes positive examples and negative examples, signs “+” and “−” can be used for the element of vector “y” of the label.

Hereinafter, a concrete example of the above embodiment will be described. Sample data were obtained as the training data and test data through the Internet from a homepage:

http://www.broad.mit.edu/cgibin/cancer/publications/p ub_paper.cgi?mode=view&paper_id=114.

These data are miRNA onset profile data of the cancer and normal tissues origin. These data included information of miRNA expression profile data of 217 classes. As the theses using these data, there is one, Lu, J., Getz, G., Miska, E., Alvarez-Saavedra, E., Lamb, J., Peck, D., Sweet-Cordero, A., Ebert, B., Mak, R., Ferrando, A., Downing, J., and Jacks, T., Horvitz, H., Golub, T. “MicroRNA expression profiles classify human cancers”, Nature, 435, 834-838, 2005.

Performance evaluation was conducted using the 89-patients' miRNA expression profile data. The configuration of those data includes 20 samples for the normal tissue and 69 samples for the cancer tissue. The parameter ν is set at 1. The specific number, M, of the repetition times included the case of M=100 and M=200 for first and second examples, respectively. As first and second comparative examples, performance was also evaluated with respect to the normal gradient boosting that maximizes the true rate for the case of M=100 and M=200.

The performance evaluation was conducted under the condition that the normal tissues and cancer tissues are positive examples and negative examples, respectively, and conducted such that the sampling is iterated for a hundred times to evaluate the mean value of AUC, with a half of the samples of each class (positive class and negative class) being used as the training data, with the remaining half being used as the test data. The following Table-1 shows the result of the performance evaluation thus conducted, showing the average of AUC obtained for each sample.

TABLE 1

| | M | Resultant AUC |
|---|---|---|
| Example-1 | M = 100 | 0.89 |
| Example-2 | M = 200 | 0.9 |
| Comparative Example-1 | M = 100 | 0.77 |
| Comparative Example-2 | M = 200 | 0.79 |

With reference to Table-1, the examples-1 and -2 of the present embodiment significantly improved the AUG as compared to the comparative examples-1 and -2.

While the invention has been particularly shown and described with reference to an exemplary embodiment thereof, the invention is not limited to the embodiment and modifications thereof. As will be apparent to those of ordinary skill in the art, various changes may be made in the invention without departing from the spirit and scope of the invention as defined in the appended claims.

1. A method used in a computer, comprising:
receiving training data including attribute data and label information, to create an initial prediction model based on said attribute data and said label information;
calculating, based on said initial prediction model used as a discriminant function, a gradient of a loss function, which is differentiable with respect to said discriminant function and satisfies a monotonous convex function, from said discriminant function and said label information;
creating a prediction model from said attribute data and said gradient while assuming that said gradient is label information of each sample of said training data; and
updating said discriminant function based on said created prediction model.

2. The method according to claim 1, wherein said loss function is an approximation of an area under curve (AUC) of receiver operating characteristic (ROC), and includes a variable as a function that is differentiable with respect to said discriminant function.

3. The method according to claim 2, wherein said loss function is an indicator function including an index as said function that is differentiable with respect to said discriminant function.

4. The method according to claim 1, wherein said updating uses the following formula:
Fₘ=Fₘ₋₁+ν Tₘ
wherein Tₘ, Fₘ, Fₘ₋₁ and ν are said prediction model created from said attribute data and said gradient, discriminant function after updating, discriminant function before updating, and normalizing term satisfying 0<ν≦1.

5. The method according to claim 1, wherein said calculating, creating and updating are consecutively conducted and iterated for a plurality of repetition times.

6. The method according to claim 1, wherein said creating of prediction model and creating of initial prediction model use a supervised learning.

7. The method according to claim 6, wherein said creating of prediction model uses a decision tree, a support vector machine, or a neural network.

8. The method according to claim 1, further comprising:
receiving test data including attribute data, to predict label information of said test data based on said attribute data of said test data and said discriminant function.

9. A system using a computer, comprising:
initial-prediction-model creation section that receives training data including attribute data and label information, to create an initial prediction model based on said attribute data and said label information;
a gradient calculation section that calculates, based on said initial prediction model used as a discriminant function, a gradient of a loss function, which is differentiable with respect to said discriminant function and satisfies a monotonous convex function, from said discriminant function and said label information;
a prediction-model creation section that creates a prediction model from said attribute data and said gradient while assuming that said gradient is label information of each sample of said training data; and
an update section that updates said discriminant function based on said created prediction model.

10. The system according to claim 9, wherein said loss function is an approximation of an area under curve (AUC) of receiver operating characteristic (ROC), and includes a variable as a function that is differentiable with respect to said discriminant function.

11. The system according to claim 10, wherein said loss function is an indicator function including an index as said function that is differentiable with respect to said discriminant function.

12. The system according to claim 1, wherein said update section uses the following formula:
Fₘ=Fₘ₋₁+ν Tₘ
wherein Tₘ, Fₘ, Fₘ₋₁ and ν are said prediction model created from said attribute data and said gradient, discriminant function after updating, discriminant function before updating, and normalizing term satisfying 0<ν≦1.

13. The system according to claim 9, wherein said gradient calculation section, said prediction-model creation section and said update section consecutively operate and iterate for a plurality of repetition times.

14. The system according to claim 9, wherein said prediction-model creation section and said initial-prediction-model creation section use a supervised learning.

15. The system according to claim 14, wherein said prediction-model creation section uses a decision tree, a support vector machine, or a neural network.

16. The system according to claim 9, further comprising:
a judgment section that receives test data including attribute data, to predict label information of said test data based on said attribute data of said test data and said discriminant function.

17. A computer-readable medium encoded with a computer program running on a computer, said computer program causes said computer to:
receive training data including attribute data and label information, to create an initial prediction model based on said attribute data and said label information;
calculate, based on said initial prediction model used as a discriminant function, a gradient of a loss function, which is differentiable with respect to said discriminant function and satisfies a monotonous convex function, from said discriminant function and said label information;
create a prediction model from said attribute data and said gradient while assuming that said gradient is label information of each sample of said training data; and
update said discriminant function based on said created prediction model.

18. The computer-readable medium according to claim 17, wherein said loss function is an approximation of an area under curve (AUC) of receiver operating characteristic (ROC), and includes a variable as a function that is differentiable with respect to said discriminant function.

19. The computer-readable medium according to claim 18, wherein said loss function is an indicator function including an index as said function that is differentiable with respect to said discriminant function.

20. The computer-readable medium according to claim 17, wherein said program further causes said computer to receive test data including attribute data, and predict label information of said test data based on said attribute data of said test data and said discriminant function.
